(19) United States
(12) Patent Application Publication
(10) Pub. No.: US 2023/0043172 A1
(43) Pub. Date: Feb. 9, 2023

(54) Adaptive Perimeter Intrusion Detection for Mobile Automation Apparatus

(71) Applicant: ZEBRA TECHNOLOGIES CORPORATION, Lincolnshire, IL (US)

(72) Inventors: Sadegh Tajeddin, Toronto (CA); Paul D. Haist, Toronto (CA); Bradley M. Scott, Mississauga (CA)

(21) Appl. No.: 17/396,276

(22) Filed: Aug. 6, 2021

(51) Int. Cl. G05D 1/02; G05D 1/00

(52) U.S. Cl. CPC G05D 1/0212; G05D 1/0088; G05D 1/0231

(57) ABSTRACT

A method includes: selecting first control parameters for a perimeter intrusion detector of a mobile automation apparatus; controlling the perimeter intrusion detector according to the first control parameters, to monitor a first perimeter surrounding the mobile automation apparatus; determining that navigational data of the mobile automation apparatus defines a maneuver satisfying perimeter modification criteria; in response to determining that a likelihood of intrusion of the first perimeter associated with the maneuver exceeds a threshold, selecting second control parameters for the perimeter intrusion detector; modifying the first perimeter to a second perimeter according to the second control parameters; and controlling the perimeter intrusion detector to monitor the second perimeter.

### BACKGROUND

A mobile automation apparatus may be deployed in an environment such as a retail facility, e.g. to traverse the facility while collecting data such as images of items within the facility. To traverse the facility, the apparatus may perform various navigational routines to detect obstacles, plan paths through the facility avoiding such obstacles, and the like. Some facilities, however, include obstacles such as corners, dead ends and the like that may cause the apparatus to be unable to continue navigation.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a mobile automation system.

FIG. 2 is a diagram illustrating a mobile automation apparatus in the system of FIG. 1, viewed from below.

FIG. 3 is a diagram illustrating a mobile automation apparatus in the system of FIG. 1, viewed from above.

FIG. 4 is a diagram illustrating the apparatus of FIG. 1 in a dead end.

FIG. 5 is a diagram illustrating certain internal components of the mobile automation apparatus.

FIG. 6 is a method of adaptive perimeter intrusion detection for the mobile automation apparatus.

FIG. 7 is a diagram illustrating an example performance of the method of FIG. 6.

FIG. 8 is a diagram illustrating a further example performance of the method of FIG. 6.

FIG. 9 is a diagram illustrating a further example performance of the method of FIG. 6.

FIG. 10 is a diagram illustrating second control parameters applied to the perimeter intrusion detector of the mobile automation apparatus.

FIG. 11 is a diagram illustrating the second control parameters of FIG. 10 in an overhead view.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: selecting first control parameters for a perimeter intrusion detector of a mobile automation apparatus; controlling the perimeter intrusion detector according to the first control parameters, to monitor a first perimeter surrounding the mobile automation apparatus; determining that navigational data of the mobile automation apparatus defines a maneuver satisfying perimeter modification criteria; in response to determining that a likelihood of intrusion of the first perimeter associated with the maneuver exceeds a threshold, selecting second control parameters for the perimeter intrusion detector; modifying the first perimeter to a second perimeter according to the second control parameters; and controlling the perimeter intrusion detector to monitor the second perimeter.

Additional examples disclosed herein are directed to a mobile automation apparatus, comprising: a perimeter intrusion detector; and a controller configured to: select first control parameters for the perimeter intrusion detector; control the perimeter intrusion detector according to the first control parameters, to monitor a first perimeter surrounding the mobile automation apparatus; determine that navigational data of the mobile automation apparatus defines a maneuver satisfying perimeter modification criteria; in response to determining that a likelihood of intrusion of the first perimeter associated with the maneuver exceeds a threshold, select second control parameters for the perimeter intrusion detector; modify the first perimeter to a second perimeter according to the second control parameters; and control the perimeter intrusion detector to monitor the second perimeter.

Further examples disclosed herein are directed to a non-transitory computer readable medium storing instructions executable by a computing device to: select first control parameters for a perimeter intrusion detector; control the perimeter intrusion detector according to the first control parameters, to monitor a first perimeter surrounding the mobile automation apparatus; determine that navigational data of the mobile automation apparatus defines a maneuver satisfying perimeter modification criteria; in response to determining that a likelihood of intrusion of the first perimeter associated with the maneuver exceeds a threshold, select second control parameters for the perimeter intrusion detector; modify the first perimeter to a second perimeter according to the second control parameters; and control the perimeter intrusion detector to monitor the second perimeter.

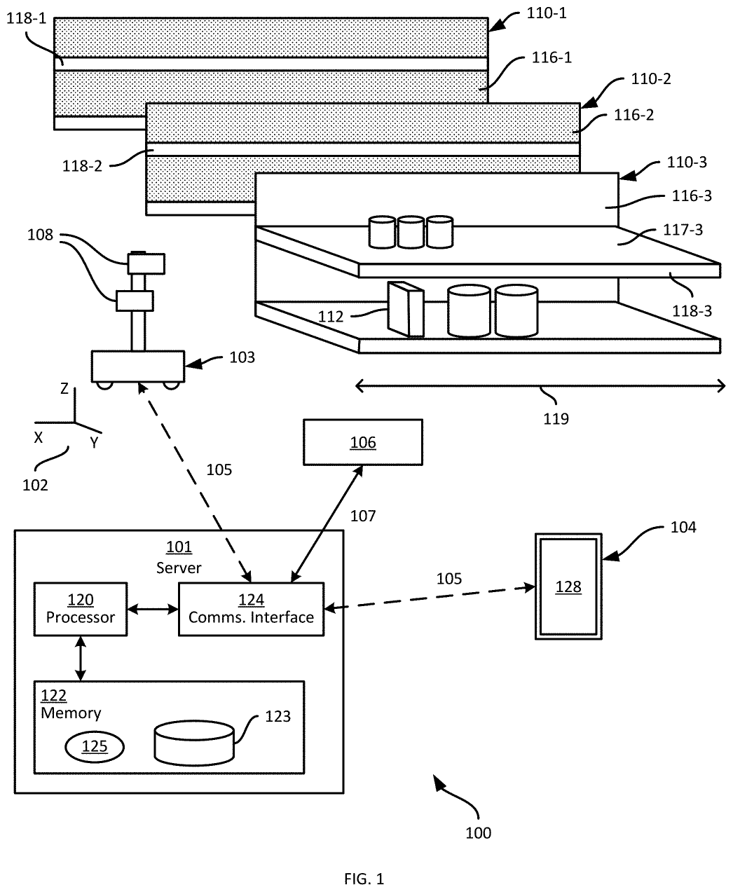

FIG. 1 depicts a mobile automation system 100 in accordance with the teachings of this disclosure. The system 100 includes a server 101 in communication with at least one mobile automation apparatus 103 (also referred to herein simply as the apparatus 103) and at least one client computing device 104 via communication links 105, illustrated in the present example as including wireless links. In the present example, the links 105 are provided by a wireless local area network (WLAN) deployed via one or more access points (not shown). In other examples, the server 101, the client device 104, or both, are located remotely (i.e. outside the environment in which the apparatus 103 is deployed), and the links 105 therefore include wide-area networks such as the Internet, mobile networks, and the like. The system 100 also includes a dock 106 for the apparatus 103 in the present example. The dock 106 is in communication with the server 101 via a link 107 that in the present example is a wired link. In other examples, however, the link 107 is a wireless link.

The client computing device 104 is illustrated in FIG. 1 as a mobile computing device, such as a tablet, smart phone or the like. In other examples, the client device 104 is implemented as another type of computing device, such as a desktop computer, a laptop computer, another server, a kiosk, a monitor, and the like. The system 100 can include a plurality of client devices 104 in communication with the server 101 via respective links 105.

The system 100 is deployed, in the illustrated example, in a retail facility including a plurality of support structures such as shelf modules 110-1, 110-2, 110-3 and so on (collectively referred to as shelf modules 110 or shelves 110, and generically referred to as a shelf module 110 or shelf 110—this nomenclature is also employed for other elements discussed herein). Each shelf module 110 supports a plurality of products 112, which may also be referred to as items. Each shelf module 110 includes a shelf back 116-1, 116-2, 116-3 and a support surface (e.g. support surface 117-3 as illustrated in FIG. 1) extending from the shelf back 116 to a shelf edge 118-1, 118-2, 118-3. A variety of other support structures may also be present in the facility, such as pegboards, tables, and the like.

The shelf modules 110 (also referred to as sub-regions of the facility) are typically arranged in a plurality of aisles (also referred to as regions of the facility), each of which includes a plurality of modules 110 aligned end-to-end. In such arrangements, the shelf edges 118 face into the aisles, through which customers in the retail facility, as well as the apparatus 103, may travel. As will be apparent from FIG. 1, the term “shelf edge” 118 as employed herein, which may also be referred to as the edge of a support surface (e.g., the support surfaces 117) refers to a surface bounded by adjacent surfaces having different angles of inclination. In the example illustrated in FIG. 1, the shelf edge 118-3 is at an angle of about ninety degrees relative to the support surface 117-3 and to the underside (not shown) of the support surface 117-3. In other examples, the angles between the shelf edge 118-3 and the adjacent surfaces, such as the support surface 117-3, is more or less than ninety degrees.

The apparatus 103 is equipped with a plurality of navigation and data capture sensors 108, such as image sensors (e.g. one or more digital cameras) and depth sensors (e.g. one or more Light Detection and Ranging (LIDAR) sensors, one or more depth cameras employing structured light patterns, such as infrared light, or the like). The apparatus 103 is deployed within the retail facility and, via communication with the server 101 and use of the sensors 108, navigates autonomously or partially autonomously along a length 119 of at least a portion of the shelves 110.

While navigating among the shelves 110, the apparatus 103 can capture images, depth measurements (e.g. point clouds) and the like, representing the shelves 110 and the items 112 supported by the shelves 110 (generally referred to as shelf data or captured data). Navigation may be performed according to a frame of reference 102 established within the retail facility. The apparatus 103 therefore tracks its pose (i.e. location and orientation) in the frame of reference 102. The tracked posed may be employed for navigation, and/or to permit data captured by the apparatus 103 to be registered to the frame of reference 102 for subsequent processing.

The server 101 includes a special purpose controller, such as a processor 120, specifically designed to control and/or assist the mobile automation apparatus 103 to navigate the environment and to capture data. The processor 120 is interconnected with a non-transitory computer readable storage medium, such as a memory 122, having stored thereon computer readable instructions for performing various functionality, including control of the apparatus 103 to navigate the modules 110 and capture shelf data, as well as post-processing of the shelf data. The memory 122 can also store data for use in the above-mentioned control of the apparatus 103 and post-processing of captured data, such as a repository 123. The repository 123 can contain, for example, a map of the facility, the image and/or depth data captured by the apparatus 103, and the like.

The memory 122 includes a combination of volatile memory (e.g. Random Access Memory or RAM) and non-volatile memory (e.g. read only memory or ROM, Electrically Erasable Programmable Read Only Memory or EEPROM, flash memory). The processor 120 and the memory 122 each comprise one or more integrated circuits. In some embodiments, the processor 120 is implemented as one or more central processing units (CPUs) and/or graphics processing units (GPUs).

The server 101 also includes a communications interface 124 interconnected with the processor 120. The communications interface 124 includes suitable hardware (e.g. transmitters, receivers, network interface controllers and the like) allowing the server 101 to communicate with other computing devices—particularly the apparatus 103, the client device 104 and the dock 106—via the links 105 and 107. The links 105 and 107 may be direct links, or links that traverse one or more networks, including both local and wide-area networks. The specific components of the communications interface 124 are selected based on the type of network or other links that the server 101 is required to communicate over. In the present example, as noted earlier, a wireless local-area network is implemented within the retail facility via the deployment of one or more wireless access points. The links 105 therefore include either or both wireless links between the apparatus 103 and the mobile device 104 and the above-mentioned access points, and a wired link (e.g. an Ethernet-based link) between the server 101 and the access point.

The processor 120 can therefore obtain data captured by the apparatus 103 via the communications interface 124 for storage (e.g. in the repository 123) and subsequent processing (e.g. to detect objects such as shelved products 112 in the captured data, and detect status information corresponding to the objects). The server 101 maintains, in the memory 122, an application 125 executable by the processor 120 to perform such subsequent processing.

The server 101 may also transmit status notifications (e.g. notifications indicating that products are out-of-stock, in low stock or misplaced) to the client device 104 responsive to the determination of product status data. The client device 104 includes one or more controllers (e.g. central processing units (CPUs) and/or field-programmable gate arrays (FPGAs) and the like) configured to process notifications and other information received from the server 101. For example, the client device 104 includes a display 128 controllable to present information received from the server 101.

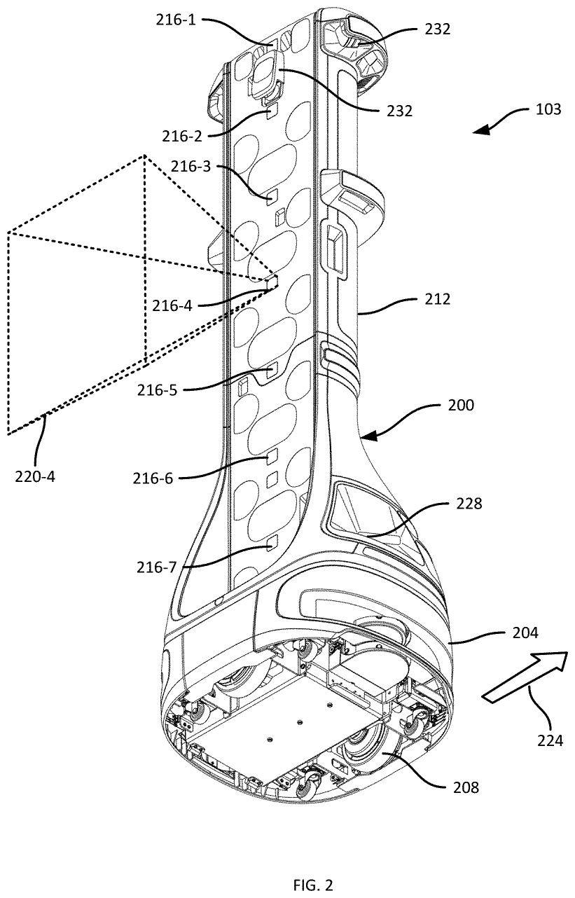

Referring to FIG. 2, the mobile automation apparatus 103 is shown in greater detail. The apparatus 103 includes a chassis 200 supporting and/or enclosing further components of the apparatus 103. The chassis 200 includes a lower portion 204 containing a locomotive assembly 208, such as one or more wheels, tracks or the like, and associated electrical motors. As will be apparent, the lower portion 204 and locomotive assembly 208, viewed from below in FIG. 2, rest on a floor of the facility and enable the apparatus 103 to travel within the facility.

The chassis 200 also includes an upper portion 212 in the form of a mast or other upright structure that is, in this example, substantially vertical when the apparatus 103 is placed on a floor in the facility. The upper portion 212 supports a plurality of sensors, including cameras 216. In the illustrated example, the apparatus 103 includes seven cameras 216-1, 216-2, 216-3, 216-4, 216-5, 216-6, and 216-7, which may have overlapping fields of view (FOVs) 220, an example 220-4 (corresponding to the camera 216-4) of which is shown in FIG. 2. The chassis 200 can also support other sensors with FOVs oriented similarly to the FOVs 220, such as depth sensors (e.g. lidar sensors and/or depth cameras). The chassis 200 can also support illumination assemblies for the cameras 216, e.g. to illuminate objects within the FOVs 220.

In operation, the apparatus 103 travels in a forward direction 224 along the length 119 of an aisle, such that the cameras 216 and other sensors mentioned above are oriented to face the shelves 110 of the aisle. The FOVs 220, in other words, are oriented substantially perpendicular to the forward direction of travel 224.

The apparatus 103 can also include navigational sensors, including a forward-facing depth sensor 228, such as a depth camera. The depth sensor 228 can be employed to detect features of the facility (e.g. shelves 110, walls, and the like) represented in the map stored in the repository 123 (and/or locally at the apparatus 103), enabling the apparatus 103 to determine its current location. The depth sensor 228 can also be employed to detect obstacles in the vicinity of the apparatus 103, in order to plan paths around such obstacles. Such obstacles may not appear in the map mentioned above, as the obstacles can include transient static objects such as boxes, pallets, items 112, and the like, and as well transient dynamic (i.e. moving) objects such as customers and workers in the facility, shopping carts, and the like.

As will be understood by those skilled in the art, the apparatus 103 can be configured to store the position of obstacles detected via the depth sensor 228 in an obstacle map (e.g. according to the detected positions of such obstacles in the frame of reference 102). The obstacle map, together with the facility map (showing the locations of walls, shelves 110 and the like) can be employed to generate paths for the apparatus 103 to traverse the facility. However, certain obstacles may not be detected by the depth sensor 228, or may move unexpectedly towards the apparatus 103 and in doing so enter the path of the apparatus 103. To mitigate the likelihood of collisions between the apparatus and such obstacles, the apparatus 103 also includes a perimeter intrusion detector configured to determine when any object (whether that object appears in the facility map, the obstacle map, or neither) crosses a perimeter surrounding the apparatus 103. When such a perimeter intrusion is detected, the apparatus 103 may execute an emergency stop, or take other suitable actions to avoid a collision.

The perimeter intrusion detector includes at least one sensor 232. The sensor 232 is, in the present example, a rangefinder mounted near or at the top of the upper portion 212 of the chassis that projects a plane of light (e.g. an IR laser plane) downwards (towards the lower portion 204 of the chassis 200) and outwards. The sensor 232 can be placed on other portions of the chassis 200 in other examples, although placement near or at the top of the chassis 200 enables the sensor 232 to cover substantially the entire height of the apparatus 103 in a field of view of the sensor 232. The apparatus 103 can include, in some examples, at least four such sensors, e.g. a forward sensor, a rearward sensor, and opposing side sensors 232, such that the planes of light projected by the sensors together form a perimeter surrounding the chassis 200. In other examples, the apparatus 103 can include larger or smaller sets of sensor 232, depending on the configuration of the perimeter to be obtained via the above-mentioned light planes.

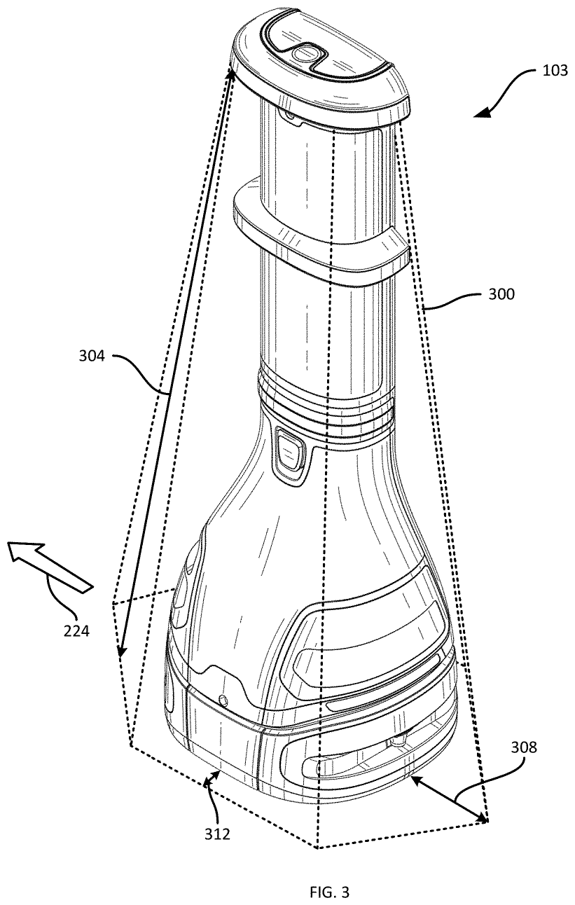

FIG. 3 illustrates the apparatus 103 and a perimeter 300 formed by a set of six light planes generated by the sensors 232 (i.e. by the perimeter intrusion detector). Therefore, the apparatus 103 can include six sensors 232, with two sensors 232 forming a pair of planes in the forward direction (the forward direction of travel 224 is indicated in FIG. 3), another two sensors 232 forming a pair of planes in a rearward direction, and another pair of planes forming opposite side planes. Each sensor 232 can be configured to report a set of observed range measurements, each indicating the distance from the sensor 232 itself to an object or other surface. In the example shown in FIG. 3, no objects intrude on the perimeter 300, and therefore each sensor 232 reports a set of ranges, such as the range 304, defining the distance from the relevant sensor 232 to the floor of the facility.

As shown in FIG. 3, the forward and rearward portions of the perimeter 300 extend further from the base of the apparatus 103 than the side portions of the perimeter 300. That is, the maximum extent 308 of the perimeter 300 at the forward and rearward portions is greater than the maximum extent 312 of the perimeter 300 at the side portions. The different extension of the perimeter 300 from the physical footprint of the apparatus 103 (defined by the lower portion 204 of the chassis 200) reflects the locomotive capabilities of the apparatus 103. In this example, the apparatus 103 can travel forwards (in the direction 224) and backwards (in a direction opposite to the direction 224), but not sideways. The perimeter 300 is configured to provide sufficient distance for the apparatus 103 to come to a complete stop upon detecting an intrusion via the sensors 232. Because the apparatus 103 does not travel sideways, little or no stopping distance is necessary. Further, extending the perimeter 300 to the sides of the apparatus 103 by the relatively small distance 312 (in comparison to the forward and rearward extent 308) enables the apparatus 103 to approach structures such as the shelves 110 more closely during scanning, as well as to navigate between obstacles or structural features while travelling in the forward direction 224.

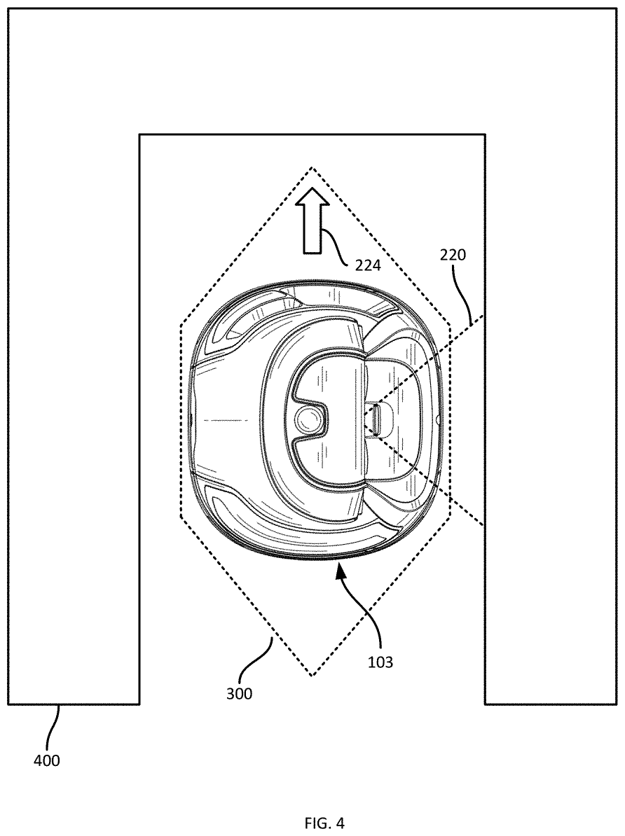

The non-circular shape of the perimeter 300, however, may interfere with navigational processes of the apparatus 103 under certain conditions. For example, as shown in FIG. 4, a dead end is formed by a structure 400 in the facility, such as a set of shelves 110. The apparatus 103 can successfully travel into the dead end in the forward direction 224, as the reduced extent of the perimeter 300 to the sides of the apparatus 103 does not result in the structure intruding on the perimeter 300. However, when the apparatus 103 attempts to rotate on the spot to exit the dead end, the larger forward and rearward extents of the perimeter 300 impinge on the structure 300, triggering an emergency stop or other interruption, despite the fact that the physical footprint of the apparatus 103 is not at risk of colliding with the structure 400.

The apparatus 103 therefore implements additional functionality, as described below, to dynamically alter the perimeter 300 under certain conditions, enabling the apparatus 103 to continue operating in scenarios such as that shown in FIG. 4. Further, the additional functionality mentioned above enables continued operation of the apparatus 103 without necessitating complex and costly modifications such as rearward obstacle detection and path planning.

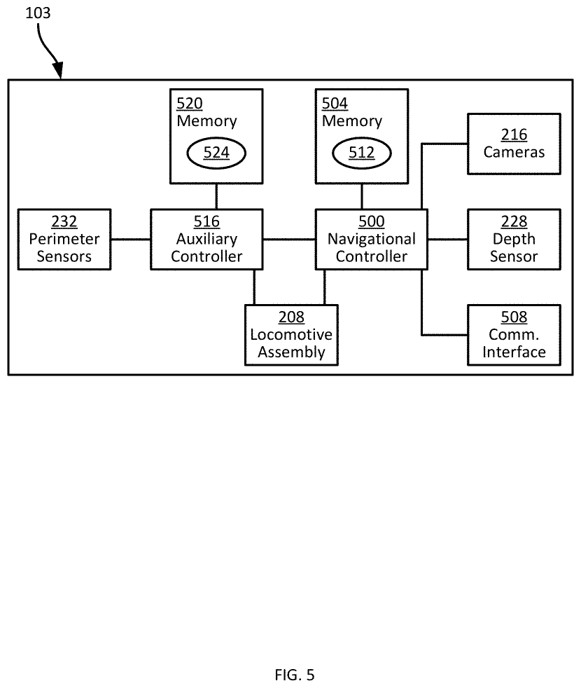

Before discussing adaptive control of the sensors 232 to dynamically alter the perimeter 300, certain internal components of the apparatus 103 will be described, with reference to FIG. 5. As shown in FIG. 5, the apparatus 103 includes a navigational controller 500, such as a central processing unit (CPU), interconnected with a non-transitory computer readable storage medium, such as a memory 504. The memory 504 includes a suitable combination of volatile memory (e.g. Random Access Memory or RAM) and non-volatile memory (e.g. read only memory or ROM, Electrically Erasable Programmable Read Only Memory or EEPROM, flash memory). The processor 500 and the memory 504 each comprise one or more integrated circuits.

The navigational controller 500 is also connected with the cameras 216 and depth sensor 228 mentioned earlier, as well as with a communications interface 516 enabling the apparatus 103 to communicate with the server 101 (e.g. via the link 105 or via the dock 106 and the link 107), for example to receive instructions to navigate to specified locations and initiate data capture operations.

The memory 504 stores computer readable instructions for execution by the controller 500, including a navigation application 512. When executed by the controller 500, the application 512 configures the controller 500 to perform various navigational functions, including obstacle detection, path planning, and control of the locomotive assembly 208 to cause the apparatus 103 to travel along planned paths.

The apparatus 103 also includes an auxiliary controller 516 connected to the perimeter sensors 232, and to a memory 520. In the illustrated example, the controller 516 and memory 520 are physically distinct from the controller 500 and memory 504, such that the auxiliary controller 516 provides a degree of redundancy to the controller 500 and the perimeter 300 is less likely to cease functioning in the event of a crash or other problem with the controller 500. In some examples, however, the apparatus 103 can include a single controller and memory that implements the functions of both controllers 500 and 516 (and their respective memories) as described herein.

The auxiliary controller 516 is also connected to either or both of the controller 500 and the locomotive assembly 208, e.g. to receive navigational data including navigational commands generated by the controller 500 for the locomotive assembly 208, a current speed of the apparatus 103, a planned path being followed by the navigational controller 500, and the like. The auxiliary controller 516 is also connected to the locomotive assembly 208, enabling the controller 516 to issue commands to the locomotive assembly 208, e.g. interrupting operations initiated by the controller 500.

The memory 520 stores a perimeter control application 524 executable by the controller 516 to configure the controller 516, both to process data received from the sensors 232 to determine whether a perimeter intrusion has occurred, and to process navigational data from the controller 500 and/or the locomotive assembly 208 (e.g. the current speed of the apparatus 103) and determine whether to dynamically alter the perimeter 300. As will be apparent, either or both of the memories 504 and 520 may also store a map of the facility, and an obstacle map.

Those skilled in the art will appreciate that the functionality implemented by the controllers 500 and/or 516 via the execution of the applications 512 and 524 may also be implemented by one or more specially designed hardware and firmware components, such as FPGAs, application-specific integrated circuits (ASICs) and the like in other embodiments. In further examples, at least some of the functionality implemented by the controllers 500 and 516 can be performed by the server 101 on behalf of the apparatus 103.

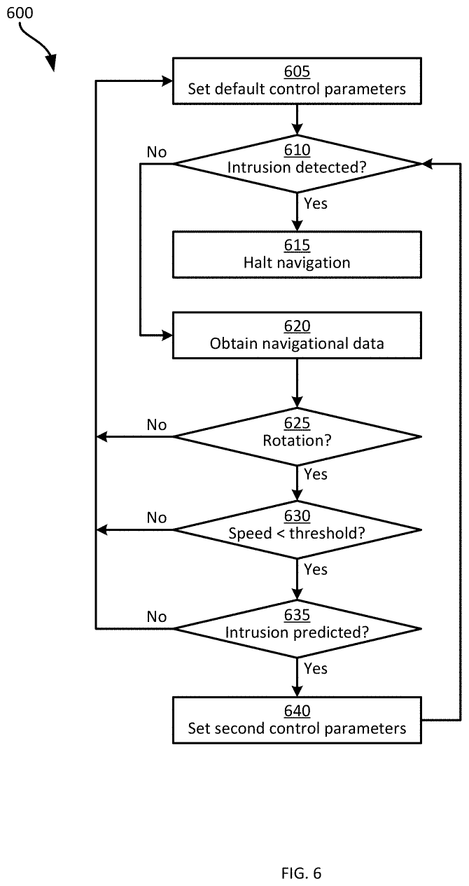

Turning now to FIG. 6, the functionality implemented by the apparatus 103 to adaptively control the perimeter 300 will be discussed in greater detail. FIG. 6 illustrates a method 600 for adaptive perimeter intrusion control, which will be discussed below in conjunction with its performance by the apparatus 103.

At block 605, e.g. in response to navigation being initiated by the navigational controller 500, the auxiliary controller 516 is configured to set default control parameters for the sensors 232 (i.e. for processing the output of the sensors 232 at the auxiliary controller 516). The control parameters for the sensors 232 can include, for example, one or more range thresholds evaluated by each sensor 232 to determine whether to report an intrusion. For example, the default configuration parameters can include a single threshold matching the range 304 shown in FIG. 3, which corresponds to the distance from the sensors 232 to the floor. As will be apparent, the distance from each sensor 232 to the floor may vary between sensors 232, and each sensor 232 may therefore have a distinct threshold in some examples. Thus, any sensor 232 observing a range smaller than the range 304 can be configured to report an intrusion. In other examples, each sensor 232 can be configured to report observed ranges below more than one threshold (e.g. a first threshold corresponding to the floor, and one or more intermediate thresholds between the floor and the sensor 232 itself).

In other examples, the sensors 232 can be implemented as depth cameras in addition to or instead of the above-mentioned range sensors, configured to capture point clouds of the area surrounding the apparatus 103. In such examples, the perimeter 300 is not defined by projected light planes, but rather by a monitored volume, e.g. defined relative to a local frame of reference of the apparatus 103. The monitored volume occupies at least a portion of the combined field of view of the depth cameras, and the auxiliary controller 516 can be configured to identify objects from data captured by the depth cameras, and determine whether such objects are within the monitored volume. In such examples, the monitored volume can have a shape similar to the perimeter 300 as shown in FIG. 3, although a wide variety of other shapes can also be used (e.g. a cone-shaped perimeter, an elliptic cone with greater extension forwards and rearwards than sideways, and the like). The default control parameters in depth camera-based implementations can include parameters defining the above volume, such as the position and size of an elliptical base of the volume, as well as an angle and height of an axis of the elliptical cone.

At block 610, the auxiliary controller 516 is configured to determine whether an intrusion of the perimeter 300 has been detected. As noted above, in some examples, the determination at block 610 can include determining whether any ranges returned by the sensors 232 fall below the threshold corresponding to the range 304. When the determination at block 610 is affirmative, navigation of the apparatus 103 is halted at block 615. For example, the auxiliary controller 516 can be configured to issue an interrupt command (e.g. an emergency stop command) to the locomotive assembly 208, overriding any other commands received at the locomotive assembly 208 from the navigational controller 500.

When the determination at block 610 is negative, regular operation of the apparatus 103 continues, and the auxiliary controller 516 is configured to obtain navigational data from the navigational controller 500. The navigational data can include a current (e.g. linear) speed of the apparatus 103, an indication of whether the apparatus 103 is rotating (e.g. an angular velocity), a current path being executed by the apparatus 103, and the like.

The auxiliary controller 516 is then configured to determine whether the navigational data defines a maneuver satisfying perimeter modification criteria. In general, maneuvers that satisfy perimeter modification criteria are maneuvers with a relatively low risk of perimeter intrusion. While the apparatus 103 performs such maneuvers, therefore, the auxiliary controller 516 can apply different, more permissive, control parameters to the sensors 232, e.g. to reduce the footprint of the perimeter 300 and reduce the likelihood of detecting an intrusion.

In some examples, the perimeter modification criteria include at least a speed criterion, e.g. an upper threshold that is satisfied if the maneuver defined by the navigational data does not exceed the upper threshold. The perimeter modification criteria can also include a movement type criterion, e.g. such that the maneuver satisfies the movement type criterion if the maneuver involves a rotation of the apparatus 103. As will now be apparent, the above criteria can also be combined, e.g. such that the criteria are satisfied only when the maneuver is a rotation-in-place, with little or no forward motion while rotating. In other examples, some forward motion (up to the upper threshold mentioned above) may be permitted while rotating.

In the example illustrated in FIG. 6, the perimeter modification criteria include both a movement type criterion, and a speed criterion. Specifically, at block 625 the auxiliary controller 516 is configured to determine whether the apparatus 103 is performing or planning a rotation. When the determination at block 625 is negative, the auxiliary controller 516 returns to block 605 (that is, the maneuver does not satisfy the criteria, having failed the first criterion). When the determination at block 625 is affirmative, the auxiliary controller 516 is configured to determine, at block 630, whether the speed of the apparatus 103 is below a threshold, e.g. 5 cm/s. When the determination at block 625 is negative, the auxiliary controller 516 returns to block 605, and the perimeter 300 is therefore maintained in the default configuration.

When the determination at block 630 is affirmative, the maneuver defined by the navigational data obtained at block 620 satisfies the perimeter modification criteria. Before modifying the perimeter 300, however, at block 635 the auxiliary controller 516 is configured to determine whether the maneuver is likely to cause an intrusion of the default perimeter 300. If no intrusion is expected, then no change is made to the perimeter 300, and the auxiliary controller returns to block 605.

The assessment at block 635 can be based on, for example, an inflated obstacle map, as will be understood by those skilled in the art. When the determination at block 635 is affirmative, the controller 516 is configured to set second control parameters for the sensors 232 at block 640. As will be discussed below, the second control parameters lead to the monitoring of a more permissive perimeter than the default perimeter 300. Following the performance of block 640, the controller 516 returns to block 610 to monitor the revised perimeter for intrusions. As will now be apparent, once any of the determinations at block 625 to 635 are negative, the control parameters for the perimeter are returned to the default settings.

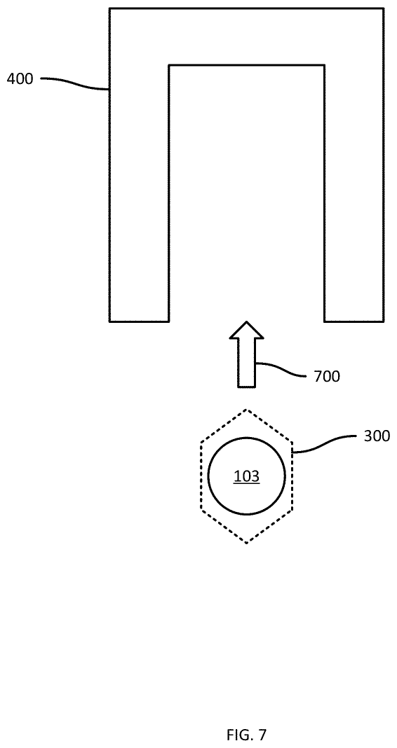

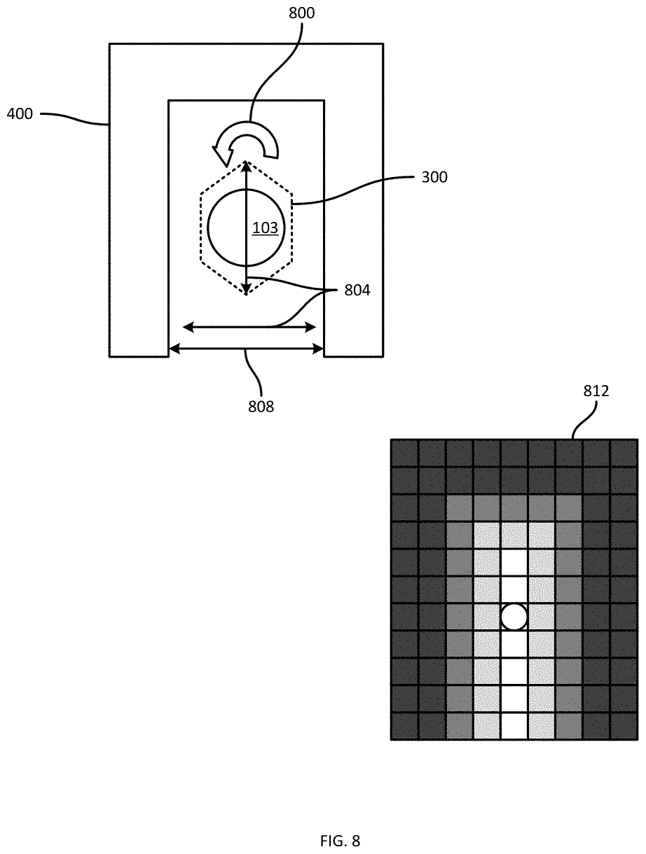

Turning to FIG. 7, in an example performance of the method 600, the determination at block 625 is negative, because the apparatus 103 is travelling forwards (in a direction 700). The default perimeter 300 is therefore maintained. As shown in FIG. 8, the apparatus 103 has entered the dead end defined by the structure 400, and the navigational data obtained at block 620 indicates that a rotation 800 on the spot is planned. The determination at block 625 is therefore affirmative, as is the determination at block 630. However, the determination at block 635 is negative, because the dead end is sufficiently wide to accommodate the default perimeter 300 during the rotation. In particular, the maximum extent 804 of the perimeter 300 is smaller than a width 808 of the dead end. That is, the structure 400 is not expected to intrude upon the perimeter 300 during the rotation. The performance of block 635 can include the use of an inflated obstacle map 812, in which cells are populated with probabilities indicating the likelihood of a collision. The cell in which the apparatus 103 is currently centered (illustrated as containing a circle in FIG. 8) contains a probability below a threshold, and the determination at block 635 is therefore negative.

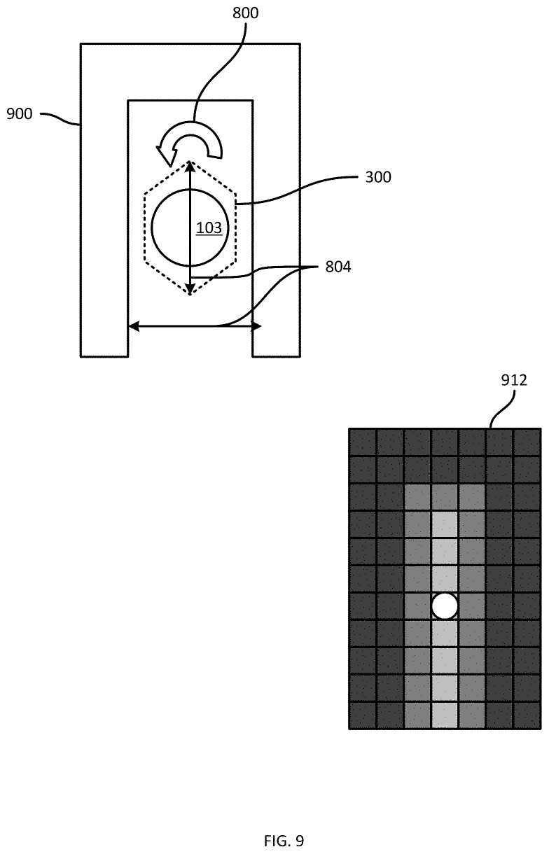

FIG. 9 illustrates another example, in which a dead end formed by a structure 900 is narrower than the maximum extent 804 of the default perimeter 300. As shown in the inflated obstacle map 912, the cell containing the apparatus 103 has been assigned a probability of collision that exceeds the threshold mentioned above, and the determination at block 635 is therefore affirmative.

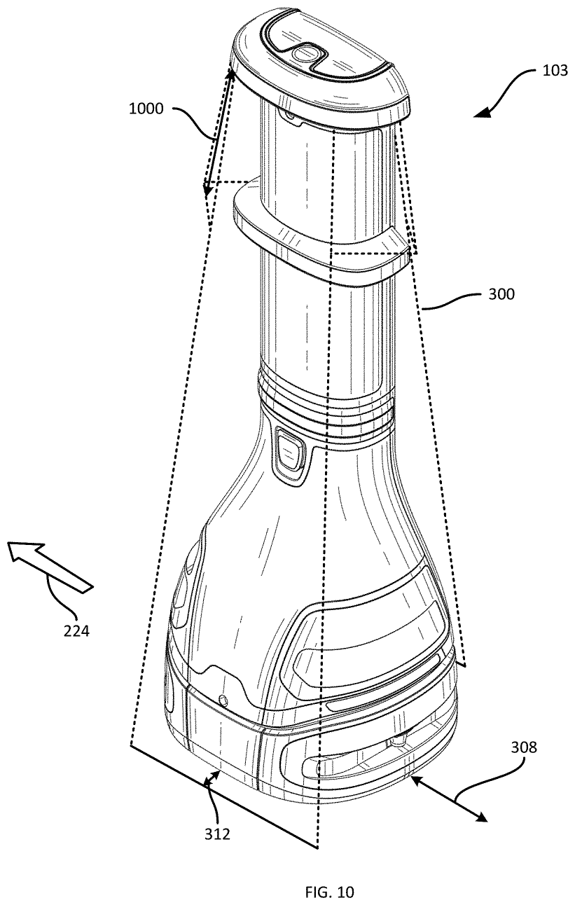

To enable the rotation 800 to complete without the structure 900 intruding on the perimeter 300, the auxiliary controller 516 is configured to set second control parameters for the sensors 232. Turning to FIG. 10, an example performance of block 640 is illustrated. In particular, the sensors 232 corresponding to the forward and rear sections of the perimeter 300 have been configured to report intrusions only for objects with ranges smaller than a second threshold 1000. It will be understood that the light planes at the forward and rear of the apparatus 103 need not be disabled, but intrusions beyond the range 1000 will not be reported. In other examples, e.g. in which the sensors 232 are depth cameras, the second control parameters can define a smaller volume surrounding the apparatus 103, e.g. with forward and rear extents substantially equal to the sideways extent 312.

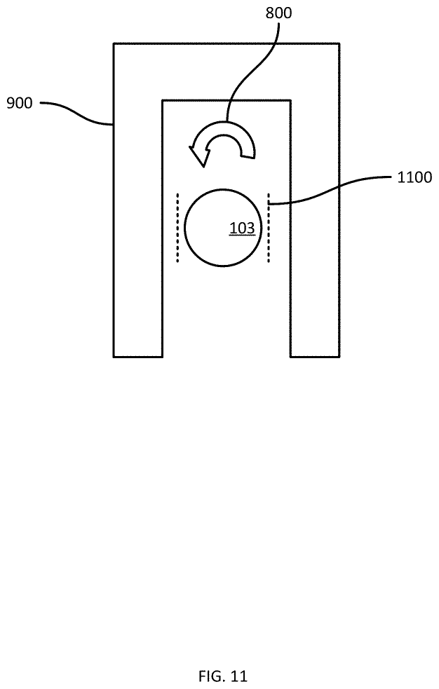

FIG. 11 illustrates an overhead view of the apparatus 103 following application of the second control parameters. As shown in FIG. 11, the default perimeter 300 has been replaced with an updated perimeter 1100, in which the forward and rear sections are monitored with a reduced region of interest (e.g. that no longer extends to the floor). As a result, the rotation 800 will not lead to intrusion of the perimeter 1100 by the structure 900. Following completion of the rotation 800, e.g. such that the forward direction 224 of the apparatus 103 points out from the dead end, the navigational controller 500 can initiate forward motion to exit the dead end, in response to which the auxiliary controller 516 will return to the default perimeter 300.

In some examples, distinct thresholds may be applied, e.g. at block 630, for the forward and rear sections of the perimeter 300. For example, the forward section of the perimeter 300 may be disabled or otherwise modified via setting of second control parameters when the apparatus 103 is traveling backwards above a threshold speed, while the rear section of the perimeter 300 may be monitored according to the first (default) control parameters. Conversely, the rear section may be disabled or otherwise modified when the apparatus 103 is traveling forwards above a threshold speed, while the front section of the perimeter 300 may be monitored according to the first (default) control parameters.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
selecting first control parameters for a perimeter intrusion detector of a mobile automation apparatus;
controlling the perimeter intrusion detector according to the first control parameters, to monitor a first perimeter surrounding the mobile automation apparatus;
determining that navigational data of the mobile automation apparatus defines a maneuver satisfying perimeter modification criteria;
in response to determining that a likelihood of intrusion of the first perimeter associated with the maneuver exceeds a threshold, selecting second control parameters for the perimeter intrusion detector;
modifying the first perimeter to a second perimeter according to the second control parameters; and
controlling the perimeter intrusion detector to monitor the second perimeter.

2. The method of claim 1, further comprising:
generating an interrupt command in response to detecting an intrusion of either the first perimeter or the second perimeter.

3. The method of claim 1, wherein the perimeter intrusion detector includes at least one range sensor projecting a light plane surrounding the mobile automation apparatus; and
wherein the first and second control parameters include respective range thresholds.

4. The method of claim 1, wherein the perimeter intrusion detector includes at least one depth camera configured to capture images of surroundings of the mobile automation apparatus; and
wherein the first and second control parameters include monitored volume definitions.

5. The method of claim 1, wherein the first control parameters include respective control parameters corresponding to each of a plurality of sections of the first perimeter; and
wherein the second control parameters alter corresponding control parameters for a subset of the sections.

6. The method of claim 5, wherein the first perimeter includes opposing side sections, a forward section, and a rear section; and
wherein the second control parameters alter corresponding control parameters for at least one of the forward section and the rear section.

7. The method of claim 6, wherein the second control parameters for the side sections are identical to the first control parameters for the side sections.

8. The method of claim 1, wherein the navigational data includes at least one of: (i) navigational commands for a locomotive assembly of the mobile automation apparatus, (ii) a current speed of the mobile automation apparatus, and (iii) a type of motion of the mobile automation apparatus.

9. The method of claim 1, wherein the maneuver is a rotation.

10. The method of claim 9, wherein the perimeter modification criteria further include a current speed of the mobile automation apparatus being below a threshold.

11. The method of claim 1, wherein the second perimeter has at least one of (i) a smaller size than the first perimeter, and (ii) a modified shape from the first perimeter.

12. A mobile automation apparatus, comprising:
a perimeter intrusion detector; and
a controller configured to:
select first control parameters for the perimeter intrusion detector;
control the perimeter intrusion detector according to the first control parameters, to monitor a first perimeter surrounding the mobile automation apparatus;
determine that navigational data of the mobile automation apparatus defines a maneuver satisfying perimeter modification criteria;
in response to determining that a likelihood of intrusion of the first perimeter associated with the maneuver exceeds a threshold, select second control parameters for the perimeter intrusion detector;
modify the first perimeter to a second perimeter according to the second control parameters; and
control the perimeter intrusion detector to monitor the second perimeter.

13. The mobile automation apparatus of claim 12, wherein the controller is further configured to:
generate an interrupt command in response to detecting an intrusion of either the first perimeter or the second perimeter.

14. The mobile automation apparatus of claim 12, wherein the perimeter intrusion detector includes at least one range sensor projecting a light plane surrounding the mobile automation apparatus; and
wherein the first and second control parameters include respective range thresholds.

15. The mobile automation apparatus of claim 12, wherein the perimeter intrusion detector includes at least one depth camera configured to capture images of surroundings of the mobile automation apparatus; and
wherein the first and second control parameters include monitored volume definitions.

16. The mobile automation apparatus of claim 12, wherein the first control parameters include respective control parameters corresponding to each of a plurality of sections of the first perimeter; and
wherein the second control parameters alter corresponding control parameters for a subset of the sections.

17. The mobile automation apparatus of claim 16, wherein the first perimeter includes opposing side sections, a forward section, and a rear section; and
wherein the second control parameters alter corresponding control parameters for at least one of the forward section and the rear section.

18. The mobile automation apparatus of claim 17, wherein the second control parameters for the side sections are identical to the first control parameters for the side sections.

19. The mobile automation apparatus of claim 12, wherein the navigational data includes at least one of: (i) navigational commands for a locomotive assembly of the mobile automation apparatus, (ii) a current speed of the mobile automation apparatus, and (iii) a type of motion of the mobile automation apparatus.

20. The mobile automation apparatus of claim 12, wherein the maneuver is a rotation.

21. The mobile automation apparatus of claim 20, wherein the perimeter modification criteria further include a current speed of the mobile automation apparatus being below a threshold.

22. A non-transitory computer readable medium storing instructions executable by a computing device to:
select first control parameters for a perimeter intrusion detector;
control the perimeter intrusion detector according to the first control parameters, to monitor a first perimeter surrounding the mobile automation apparatus;
determine that navigational data of the mobile automation apparatus defines a maneuver satisfying perimeter modification criteria;
in response to determining that a likelihood of intrusion of the first perimeter associated with the maneuver exceeds a threshold, select second control parameters for the perimeter intrusion detector;
modify the first perimeter to a second perimeter according to the second control parameters; and
control the perimeter intrusion detector to monitor the second perimeter.
